(19) United States
(12) Patent Application Publication
(10) Pub. No.: US 2014/0208025 A1
(43) Pub. Date: Jul. 24, 2014

(54) RAID CONTROLLER AND COMMAND PROCESSING METHOD THEREOF

(71) Applicant: Sony Corporation, Tokyo (JP)

(72) Inventors: Ryuichi Asano, Kanagawa (JP); Chiharu Sakai, Kanagawa (JP); Yoshihide Fujimoto, Kanagawa (JP); Rikiya Natsuaki, Kanagawa (JP)

(73) Assignee: Sony Corporation, Tokyo (JP)

(21) Appl. No.: 14/153,930

(22) Filed: Jan. 13, 2014

(30) Foreign Application Priority Data
Jan. 18, 2013 (JP) 2013-007351

(51) Int. Cl. G06F 3/06

(52) U.S. Cl. CPC G06F 3/0659; G06F 3/0689; G06F 3/0619
USPC 711/114

(57) ABSTRACT

A RAID controller includes a first serial interface, a second serial interface, and a control unit. To the first serial interface, a host device is connectable. The second serial interface has a plurality of ports to each of which a storage device capable of executing a command is connectable. The control unit controls the second serial interface so that, when a significant value is written to a predetermined control register which is determined to be unused on a serial interface standard for a type of the command obtained from the host device through the first serial interface among a control register group to which a parameter is written, the value is regarded as port information for specifying the port to which the storage device caused to execute the command is connected, and the command is transferred to the storage device via the port specified by the port information.

### CROSS REFERENCE TO RELATED APPLICATIONS

This application claims the benefit of Japanese Priority Patent Application JP 2013-007351 filed Jan. 18, 2013, the entire contents of which are incorporated herein by reference.

### BACKGROUND

The present disclosure relates to a RAID controller that uses a serial ATA interface and a command processing method thereof.

As an interface with a storage device or the like, a serial ATA (serial AT attachment) is known. The serial ATA is a standard which is software-compatible with a parallel ATA. For the serial ATA, as a function for connecting a plurality of serial ATA devices to a host device, a port multiplier that branches one port of the host device into a plurality of ports is provided.

In the serial ATA standard, to make it possible to use the port multiplier, a 4-bit PM Port specification unit is defined in an FIS (frame information structure). The PM Port specification unit is a part for specifying, from among storage devices connected to a plurality of ports of the port multiplier, a storage device connected to a port to which a command is given.

In such an environment that a plurality of storage devices compliant with the serial ATA form RAID (redundant arrays of inexpensive disks), the port multiplier is useful as means for specifying a storage device and access the device from a host device. For example, the port multiplier can be used for the case where information relating to a diagnosis result of a self-diagnosis function such as an S.M.A.R.T (self-monitoring, analysis and reporting technology) mounted on a storage device is obtained by a host device, and a degradation condition of the storage device is managed, for example.

It should be noted that, as prior art documents relating to a RAID controller that uses the serial ATA interface and a command processing method thereof, Japanese Patent Application Laid-open Nos. 2000-207137 and 2009-110162 are disclosed.

### SUMMARY

In order to access individual storage devices that constitute RAID from a host device by using the function of the port multiplier, a host bus adapter and a RAID controller have to be compliant with the port multiplier. However, these days, host bus adaptors are not compliant with the port multiplier in many cases.

Alternatively, such a method that an operation of a RAID engine of a RAID controller is switched by a CPU, and commands are issued to individual storage devices is conceivable. In this method, however, a program or the like for a CPU in a RAID controller has to be provided, resulting in an increase in cost.

In view of the above, demanded is a technology for increasing a degree of freedom for accesses to storage devices that form RAID from a host device at a lower cost without using the function of the port multiplier.

Further, when receiving an IDENTIFY DEVICE command from a host device, a typical RAID controller compliant with the serial ATA returns device information such as a capacity, a name, and performance of one integrated storage device, with a plurality of storage devices that form RAID as the one integrated storage device. Therefore, it is difficult to individually obtain device information of each of the storage devices.

In view of the above-mentioned circumstances, it is desirable to provide a RAID controller and a command processing method thereof which can increase the degree of freedom for accesses to storage devices that form RAID from a host device.

According to an embodiment of the present disclosure, there is provided a RAID controller including a first serial interface, a second serial interface, and a control unit. To the first serial interface, a host device is connectable. The second serial interface has a plurality of ports to each of which a storage device capable of executing a command is connectable. The control unit is configured to control the second serial interface so that, when a significant value is written to a predetermined control register which is determined to be unused on a serial interface standard for a type of the command obtained from the host device through the first serial interface among a control register group to which a parameter is written, the value is regarded as port information for specifying the port to which the storage device caused to execute the command is connected, and the command is transferred to the storage device via the port specified by the port information.

When the significant value is not written to the unused control register, the control unit may control the second serial interface to convert the command from the host device to a command for operating RAID (redundant arrays of inexpensive disks) and transfer the command for operating the RAID to each of the plurality of storage devices via the plurality of ports.

By the RAID controller, even if the host device and the RAID controller are not compliant with a port multiplier, it is possible to individually access the storage devices connected to the RAID controller from the host device. A range of changing the command protocol between the host device and the RAID controller suffices, so it is possible to suppress a cost rise.

The first serial interface and the second serial interface may be serial ATA (serial AT attachment) interfaces.

When the control unit receives a first IDENTIFY DEVICE command from the host device, the control unit may issue a second IDENTIFY DEVICE command to the plurality of storage devices connected to the plurality of ports, obtain device information from each of the storage devices, and return the device information to the host device.

The control unit may return device information of one integrated storage device and the device information of the storage devices to the host device with the plurality of storage devices connected to the plurality of ports as the one integrated storage devices.

According to another embodiment of the present disclosure, there is provided a command processing method, including connecting a host device to a first serial interface and connecting storage devices each of which is capable of executing a command to a plurality of ports of a second serial interface, obtaining the command and a parameter from the host device through the first serial interface, determining whether a significant value is written to a predetermined control register which is determined to be unused on a serial interface standard for a type of the command obtained among a control register group to which the parameter is written, and regarding, when the significant value is written, the value as port information for specifying the port to which the storage device caused to execute the command is connected, and transferring the command to the storage device via the port specified by the port information.

As described above, according to the embodiments of the present disclosure, the degree of freedom for the accesses to the storage devices that constitute the RAID from the host device is increased.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing the structure of a RAID system according to a first embodiment of the present disclosure;

FIG. 2 is a schematic diagram of an individual access to the storage devices in the RAID system shown in FIG. 1;

FIG. 3 is a flowchart of an operation of the individual access to the storage devices shown in FIG. 2;

FIG. 4 is a schematic diagram of an access to device information of the storage devices by the RAID system shown in FIG. 1;

FIG. 5 is a flowchart of an operation of the access to the device information of the storage devices shown in

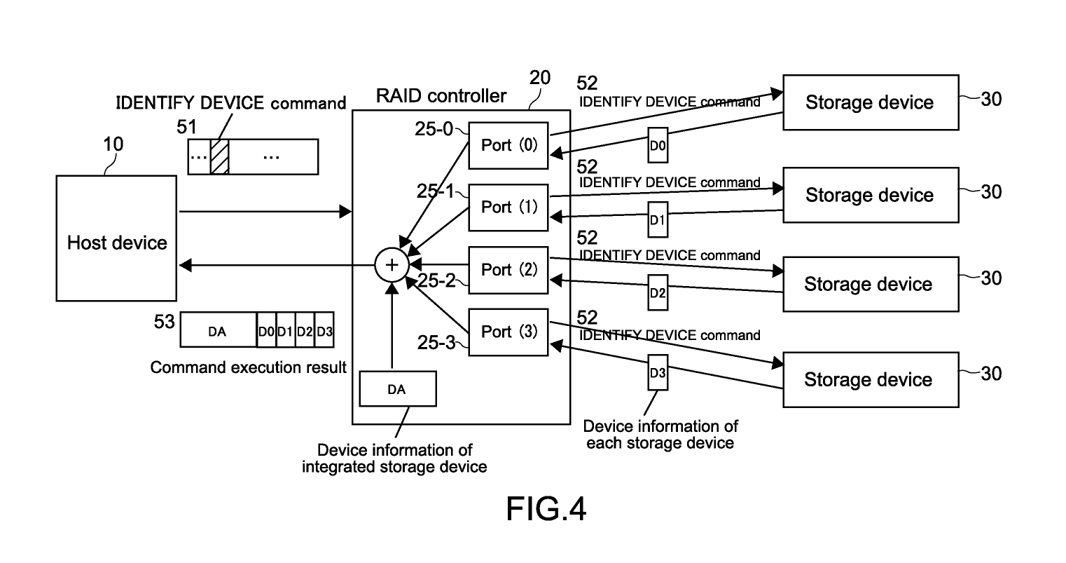

FIG. 4;

FIG. 6 is a diagram showing the structure of an input task file register on an ATA standard of an IDENTIFY DEVICE command;

FIG. 7 is an explanatory diagram for explaining a transfer of port information using an unused register in the input task file register of the IDENTIFY DEVICE command shown in FIG. 6;

FIG. 8 is a diagram showing the structure of an input task file register on the ATA standard of a Write DMA EXT command; and

FIG. 9 is a diagram for explaining a transfer of port information using an unused register in the input task file register of the Write DMA EXT command shown in FIG. 8.

### DETAILED DESCRIPTION OF EMBODIMENTS

Hereinafter, embodiments of the present disclosure will be described with reference to the drawings.

### First Embodiment

First, the outline of a RAID system that uses a RAID controller according to a first embodiment of the present disclosure will be described.

### (Outline of RAID System)

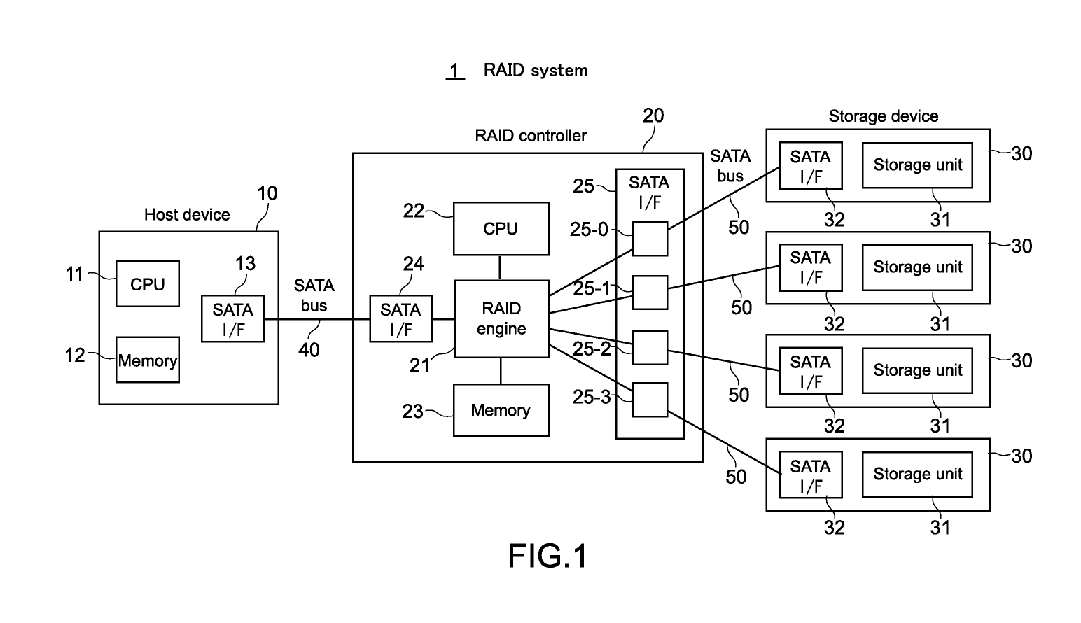

FIG. 1 is a block diagram showing the structure of a RAID system according to a first embodiment of the present disclosure.

A RAID system 1 includes a host device 10, a RAID controller 20, and a plurality of storage devices 30. The host device 10 and the RAID controller 20 are connected to each other via a serial ATA bus 40. Further, the RAID controller 20 and the storage devices 30 are individually connected to each other via serial ATA buses 50.

The host device 10 includes a CPU 11, a memory 12, a serial ATA interface 13, and the like. The host device 10 may be an AT-compatible personal computer or the like. The host device 10 issues various ATA commands to the RAID controller 20 through the serial ATA interface 13 via the serial ATA bus 40, and receives an execution result of the ATA commands via the serial ATA bus 40 from the RAID controller 20.

The RAID controller 20 performs a process for operating the plurality of connected storage devices 30 as one storage logically. To the RAID controller 20, various RAID levels such as a RAID 0, a RAID 3, and a RAID 5 can be applied. In this embodiment, for example, the assumption is made that the RAID 0 (striping) for writing data to the plurality of storage devices 30 in a distributed manner is applied.

The RAID controller 20 is provided with a RAID engine 21, a CPU 22, a memory 23, a serial ATA interface 24 on the side of the host device 10, and a serial ATA interface 25 on the side of the storage devices 30. The serial ATA interface 24 on the side of the host device 10 corresponds to a first serial interface in the scope of the appended claims, and the serial ATA interface 25 on the side of the storage devices 30 corresponds to a second serial interface in the scope of the appended claims.

The RAID engine 21 is a calculator that performs various calculations for the RAID operation. The RAID engine 21 corresponds to a control unit in the scope of the appended claims.

The RAID engine 21 generates commands to be issued to the storage devices 30 on the basis of a parameter and the ATA command issued by the host device 10, for example. The CPU 22 performs overall control for the RAID controller 20. The memory 22 stores firmware and the like of the RAID engine 21. To the serial ATA interface 25 on the side of the storage devices 30, a plurality of ports 25-0, 25-1, 25-2, and 25-3 are provided. To the ports 25-0, 25-1, 25-2, and 25-3, the storage devices 30 are connected.

It should be noted that the RAID controller 20 may be compliant with a port multiplier or not.

The storage devices 30 each function as an ATA device, which is a drive in conformity to the ATA standard. The storage device 30 includes a storage unit 31 such as a hard disk drive (HDD) and a solid-state drive (SSD). The storage devices 30 are provided with serial ATA interfaces 32, which are respectively connected to the ports 25-0, 25-1, 25-2, and 25-3 of the serial ATA interface 25 of the RAID controller 20 on the side of the storage devices 30 via the serial ATA buses 50.

### (Operation of RAID System)

In the RAID system 1, the following accesses can be performed with respect to the plurality of storage devices 30 that constitute the RAID from the host device 10.
1. individual access to storage devices
2. access to device information of storage devices

Hereinafter, the accesses mentioned above will be described.

In the RAID system 1, by changing a command protocol between the host device 10 and the RAID controller 20, it becomes possible to access to the individual storage devices 30 through the RAID controller 20 from the host device 10.

According to the ATA standard, in a control register (task file register), there is a register (unused register) which is not used for a transfer of a parameter depending on types of the ATA commands. By using the unused register, port information can be transferred to the RAID controller 20 from the host device 10. Thus, it is possible to individually access the storage devices 30 connected to the RAID controller 20 from the host device 10 without using the port multiplier function.

It should be noted that the unused register in the control register includes the following specifically.

FIG. 6 is a diagram showing the structure of an input task file register on the ATA standard of an IDENTIFY DEVICE command. Here, a register to which “na” is written refers to the unused register. In this way, according to the ATA standard, in the case of the IDENTIFY DEVICE command, for example, a Sector Count register is an unused register. Therefore, as shown in FIG. 7, by using the Sector Count register as the unused register, port information (Port No. value) can be transferred.

It should be noted that in the example of FIG. 7, the port information (Port No. value) can take any one of the values of “00” to “03”. Here, the values of “00” to “03” of the port information (Port No. value) respectively correspond to the four ports 25-0, 25-1, 25-2, and 25-3 of the serial ATA interface 25 in the RAID controller 20.

FIG. 8 is a diagram showing the structure of an input task file register on the ATA standard of a Write DMA EXT command. In the case of the Write DMA EXT command, a Feature register is “Reserve”, which is an unused register. Therefore, as shown in FIG. 9, by using a Current portion of the Feature register as the unused register, the port information (Port No. value) can be transferred.

In addition to this, there are unused registers corresponding to the ATA commands, so it is possible to transfer the port information (Port No. value) by using those in the same way.

Subsequently, such an operation will be described in detail.

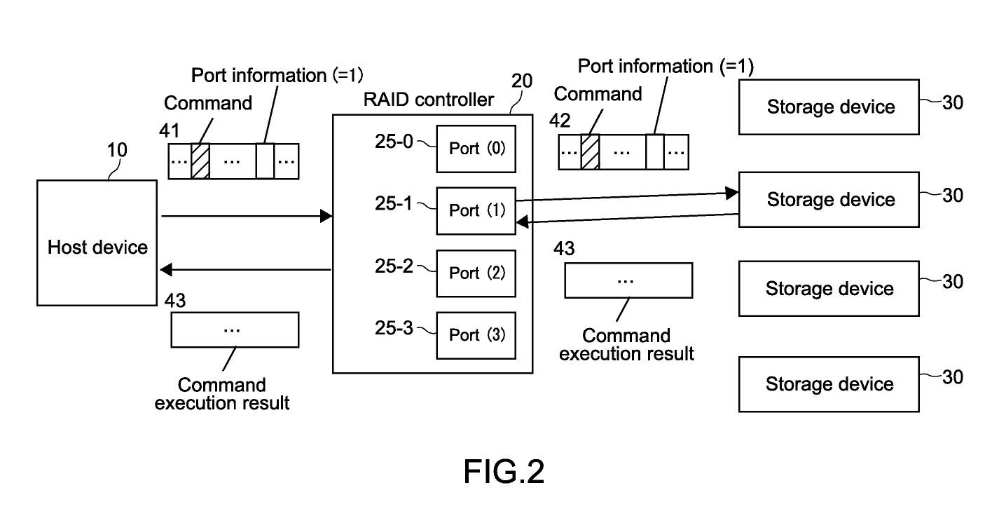

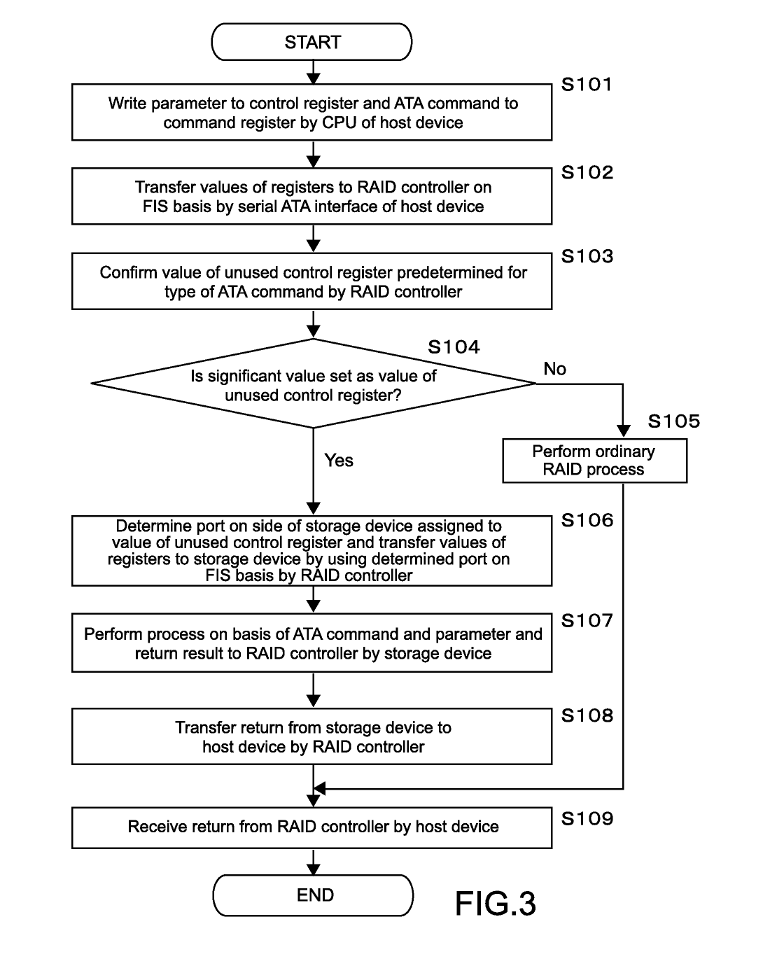

FIG. 2 is a schematic diagram showing the individual access to the storage device 30 by the RAID system 1 according to this embodiment. FIG. 3 is a flowchart thereof.

First, the CPU 11 of the host device 10 writes the parameter of the ATA command to the control register and writes the ATA command to a command register (Step S101).

At this time, in the case where the individual access to the storage device 30 is performed, the CPU 11 of the host device 10 writes, to the unused register predetermined in accordance with the type of the ATA command, the port information such as a port number of the port to which the storage device 30 desired to be accessed is connected, out of the plurality of storage devices connected to the ports 25-0, 25-1, 25-2, and 25-3 of the serial ATA interface 25 of the RAID controller 20.

The serial ATA interface 13 of the host device 10 generates an FIS 41 on the basis of the value written to the control register and the command register and transfers the FIS 41 to the RAID controller 20 via the serial ATA bus 40 (Step S102).

The serial ATA interface 24 of the RAID controller 20 on the side of the host device 10 writes the content of the FIS 41 transferred from the host device 10 to the control register and the command register provided thereto. The RAID engine 21 of the RAID controller 20 confirms a value of the unused register predetermined for the type of the ATA command written to the command register of the serial ATA interface 24 (Step S103).

In this confirmation, in the case where a significant value is not set as the value of the unused register predetermined for the type of the ATA command (NO in Step S104), the RAID engine 21 of the RAID controller 20 converts the ATA command to perform an ordinary RAID operation and issues the converted command to the storage devices 30 (Step S105).

Further, in the case where the significant value is set as the value of the unused register predetermined for the type of the ATA command (YES in Step S104), the RAID engine 21 of the RAID controller 20 regards the ATA command as a command for the individual access to the storage device 30 and performs the following process.

That is, the RAID engine 21 of the RAID controller 20 determines the port 25-0, 25-1, 25-3, or 25-3 of the serial ATA interface 25 on the side of the storage devices 30 corresponding to the value of the unused register and transfers an FIS 42, the content of which is the same as the received FIS 41, to the storage device 30 connected to the port (Step S106). It should be noted that the FIS 42 may not include the port information.

The serial ATA interface 32 of the storage device 30 writes the content of the received FIS 41 to the control register and the command register. The storage unit 31 of the storage device 30 executes the process on the basis of the parameter written to the control register and the ATA command written to the command register and returns an execution result 43 to the RAID controller 20 (Step S107).

The RAID engine 21 of the RAID controller 20 transfers the execution result 43 returned from the storage device 30 to the host device 10 (Step S108). The CPU 11 of the host device 10 receives the execution result 43 returned from the RAID controller 20 (Step S109).

Through the process described above, the individual access to the storage devices 30 without using the port multiplier function is completed.

### (2. Access to Device Information of Storage Devices)

In the RAID system 1, when receiving the IDENTIFY DEVICE command (first IDENTIFY DEVICE command) from the host device 10, the RAID controller 20 issues an IDENTIFY DEVICE command (second IDENTIFY DEVICE command) to the plurality of storage devices 30, obtains the device information from the storage devices 30, and returns the device information to the host device 10 with the device information added to the device information of the integrated storage device.

Subsequently, such an operation will be described in detail.

FIG. 4 is a schematic diagram showing an access to the device information of the storage devices 30 by the

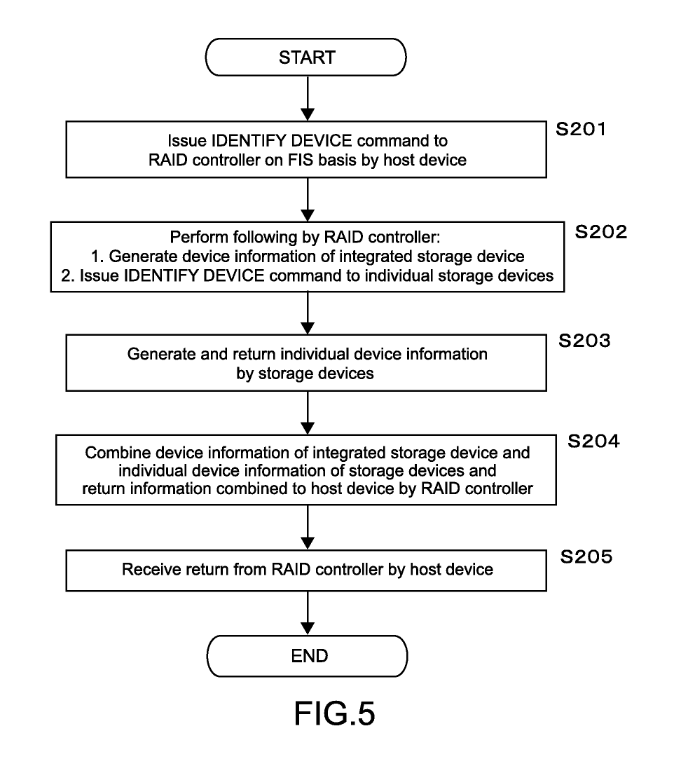

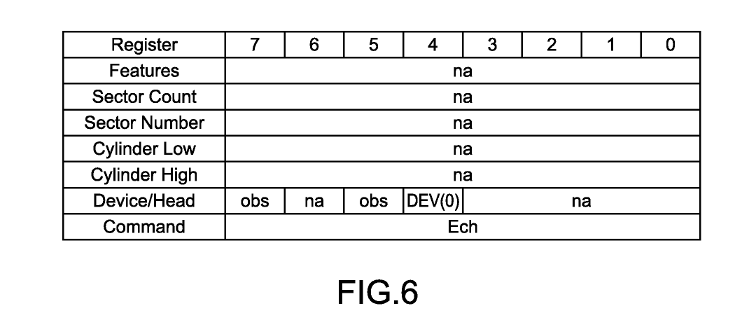

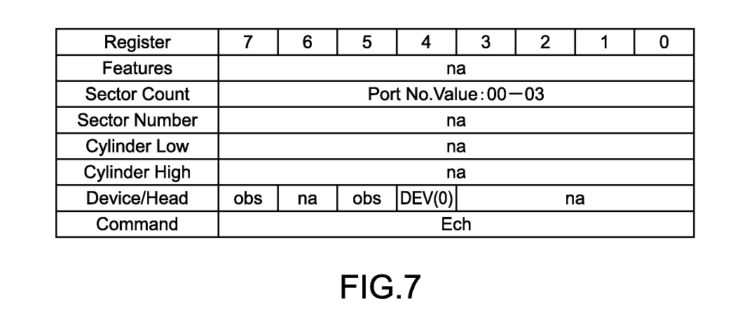

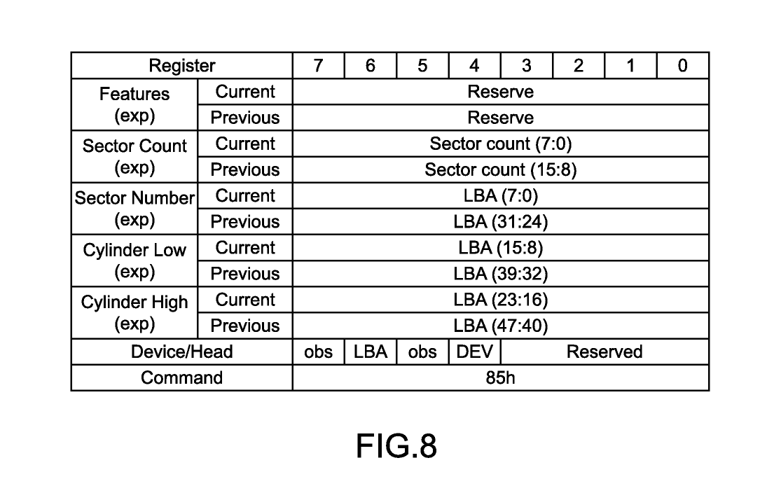

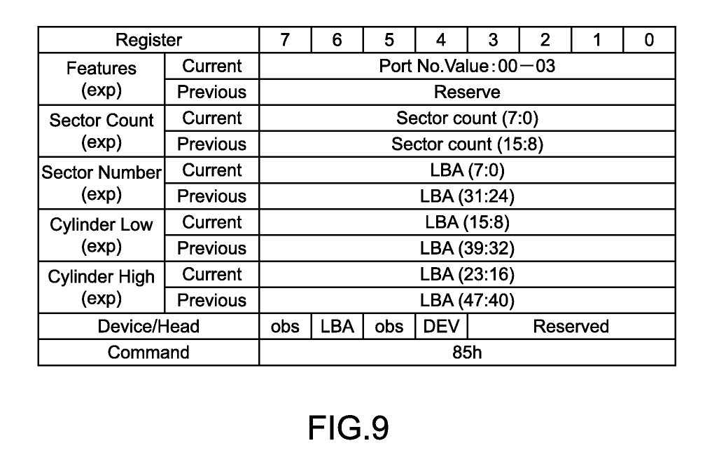

RAID system 1 according to this embodiment. FIG. 5 is a flowchart thereof.

First, an IDENTIFY DEVICE command 51 is issued from the host device 10 to the RAID controller 20 on an FIS basis (Step 201).

When receiving the IDENTIFY DEVICE command 51, the RAID controller 20 performs the following two processes (Step S202).
1. Device information DA relating to the integrated storage device is generated.
2. An IDENTIFY DEVICE command 52 is transferred to each of the storage devices 30 on the FIS basis.

Upon reception of the IDENTIFY DEVICE command 52, the storage devices 30 generate the device information such as the capacity, the name, and the performance thereof as pieces of individual device information D0, D1, D2, and D3 and return the information to the RAID controller 20 (Step S203).

The RAID engine 21 of the RAID controller 20 returns, to the host device 10, the pieces of individual device information D0, D1, D2, and D3 returned from all the storage devices 30 and the device information DA of the integrated storage device as an execution result 53 of the IDENTIFY DEVICE command 51 (Step S204).

The host device 10 receives the execution result 53 returned from the RAID controller 20 (Step S205).

Through the above processes, the access to the device information of the storage devices 30 is completed.

As described above, by the RAID system 1 according to this embodiment, the following effect can be obtained.

1.Even if the host device 10 and the RAID controller 20 are not compliant with the port multiplier, it is possible to perform the individual access to the storage devices 30 connected to the RAID controller 20 from the host device 10. A range of changing the command protocol between the host device 10 and the RAID controller 20 suffices, so it is possible to suppress a cost rise.

2.It is possible to obtain the device information of the storage devices 30 connected to the RAID controller 20 by the host device 10.

In this embodiment, the serial ATA is used as the serial interface. The present technology can also be applied to the case where another serial interface such as a serial SCSI (small computer system interface) is used.

It should be noted that the present disclosure can take the following configurations.

(1) A RAID controller, including:
a first serial interface to which a host device is connectable;
a second serial interface having a plurality of ports to each of which a storage device capable of executing a command is connectable; and
a control unit configured to control the second serial interface so that, when a significant value is written to a predetermined control register which is determined to be unused on a serial interface standard for a type of the command obtained from the host device through the first serial interface among a control register group to which a parameter is written, the value is regarded as port information for specifying the port to which the storage device caused to execute the command is connected, and the command is transferred to the storage device via the port specified by the port information.

(2) The RAID controller according to Item (1), in which
when the significant value is not written to the unused control register, the control unit controls the second serial interface to convert the command from the host device to a command for operating RAID (redundant arrays of inexpensive disks) and transfer the command for operating the RAID to each of the plurality of storage devices via the plurality of ports.

(3) The RAID controller according to Item (1) or (2), in which
the first serial interface and the second serial interface are serial ATA (serial AT attachment) interfaces.

(4) The RAID controller according to any one of Items (1) to (3), in which
when the control unit receives a first IDENTIFY DEVICE command from the host device, the control unit issues a second IDENTIFY DEVICE command to the plurality of storage devices connected to the plurality of ports, obtains device information from each of the storage devices, and returns the device information to the host device.

It should be understood by those skilled in the art that various modifications, combinations, sub-combinations and alterations may occur depending on design requirements and other factors insofar as they are within the scope of the appended claims or the equivalents thereof.

What is claimed is:

1. A RAID controller, comprising:
a first serial interface to which a host device is connectable;
a second serial interface having a plurality of ports to each of which a storage device capable of executing a command is connectable; and
a control unit configured to control the second serial interface so that, when a significant value is written to a predetermined control register which is determined to be unused on a serial interface standard for a type of the command obtained from the host device through the first serial interface among a control register group to which a parameter is written, the value is regarded as port information for specifying the port to which the storage device caused to execute the command is connected, and the command is transferred to the storage device via the port specified by the port information.

2. The RAID controller according to claim 1, wherein
when the significant value is not written to the unused control register, the control unit controls the second serial interface to convert the command from the host device to a command for operating RAID (redundant arrays of inexpensive disks) and transfer the command for operating the RAID to each of the plurality of storage devices via the plurality of ports.

3. The RAID controller according to claim 2, wherein
the first serial interface and the second serial interface are serial ATA (serial AT attachment) interfaces.

4. The RAID controller according to claim 1, wherein
when the control unit receives a first IDENTIFY DEVICE command from the host device, the control unit issues a second IDENTIFY DEVICE command to the plurality of storage devices connected to the plurality of ports, obtains device information from each of the storage devices, and returns the device information to the host device.

5. The RAID controller according to claim 4, wherein
the control unit returns device information of one integrated storage device and the device information of the storage devices to the host device with the plurality of storage devices connected to the plurality of ports as the one integrated storage devices.

6. A command processing method, comprising:
connecting a host device to a first serial interface and connecting storage devices each of which is capable of executing a command to a plurality of ports of a second serial interface;
obtaining the command and a parameter from the host device through the first serial interface;
determining whether a significant value is written to a predetermined control register which is determined to be unused on a serial interface standard for a type of the command obtained among a control register group to which the parameter is written; and
regarding, when the significant value is written, the value as port information for specifying the port to which the storage device caused to execute the command is connected, and transferring the command to the storage device via the port specified by the port information.
